(19) United States
(12) Patent Application Publication
(10) Pub. No.: US 2001/0005446 A1
(43) Pub. Date: Jun. 28, 2001

(54) Multimedia information playback apparatus and method

(76) Inventor: Hiroshi Uchikoga, Tokyo (JP)

Correspondence Address: Eric B. Meyertons, CONLEY, ROSE & TAYON, P.C., P.O. BOX 398, AUSTIN, TX, 78767-0398, US

(21) Appl. No.: 09/748,817

(22) Filed: Dec. 22, 2000

(30) Foreign Application Priority Data
Dec. 27, 1999 (JP) 371105/1999
Oct. 20, 2000 (JP) 322018/2000

(51) Int. Cl. H04N 5/91; H04N 5/781; H04N 5/85; H04N 5/90

(52) U.S. Cl. 386/94; 386/125

(57) ABSTRACT

A multimedia information playback apparatus includes a first input unit, second input unit, and playback unit. The first input unit receives multimedia information including video data and audio data distributed from a first distribution source. The second input unit receives control information distributed from a second distribution source. The playback unit plays back the multimedia information received by the first input unit on the basis of the control information received by the second input unit. A multimedia information playback method is also disclosed.

### BACKGROUND OF THE INVENTION

The present invention relates to a multimedia information playback apparatus and method for playing back multimedia information recorded on a recording medium such as a DVD-ROM, CD-ROM, or hard disk, and multimedia information such as video data and audio data distributed from a network server.

In a DVD-ROM, various data such as video data are played back on the basis of control information described in a UDF (Universal Disk Format)/IS09660 bridge format. The UDF/IS09660 bridge format is a combination of UDF and IS09660 file systems. File information in the UDF/IS09660 bridge format can be readably accessed by both an apparatus adopting UDF and an apparatus adopting IS09660.

Such control information is necessary in playing back and controlling multimedia information by a playback apparatus, and is generally stored together with multimedia information stored in a DVD-ROM. A control information file has an extension IFO so as to identify application software. To the contrary, multimedia information has an extension VOB.

A file having the extension IFO will be called an IFO file, and a file having the extension VOB will be called a VOB file. As the control information, the IFO file describes commands, which define operations permitted to the user or designate the position of multimedia data to be read next. If conditions defined in the commands are satisfied, the commands are executed to change playback.

The control information includes not only an IFO file, but also commands necessary for read control, e.g., the pre- and post-commands of a program chain in a VOB file.

Multimedia data to be read out are sequentially described as a program chain in a VOB file in the read order. Commands are executed to change a playback order defined in the program chain.

The playback order of multimedia information such as pictures recorded on a DVD-ROM is described in control information such as an IFO file. Pieces of control information are analyzed by a program in a playback apparatus. Desired compressed data is read out from a VOB file in the DVD-ROM, played back, and controlled.

The playback apparatus having this arrangement always plays back multimedia information such as pictures recorded on a DVD-ROM on the basis of the contents of an IFO file, and thus cannot play back multimedia information in a different playback order.

To the contrary, Japanese Patent Laid-Open No. 11-162089 entitled “Data Reproduction Controller, Storage Medium Used for The Same, and Data Reproduction Control Method” discloses a technique of playing back pictures in an order different from that defined in control information recorded on a medium in advance. If, however, a VOB file on a DVD-ROM is to be played back by replacing an IFO file with another one, as disclosed in this reference, a third party may perform illicit copying or tamper because the IFO file itself can be copied or tampered by a general-purpose computer or the like.

### SUMMARY OF THE INVENTION

It is an object of the present invention to enable playback in a playback order different from the contents of an IFO file recorded on a storage device and prevent illicit copying or tamper of the IFO file by a third party when multimedia information such as pictures recorded on the storage device such as a DVD-ROM is to be played back.

To achieve the above object, according to the present invention, there is provided a multimedia information playback apparatus comprising first input means for receiving multimedia information including video data and audio data distributed from a first distribution source, second input means for receiving control information distributed from a second distribution source, and playback means for playing back the multimedia information received by the first input means on the basis of the control information received by the second input means.

### BRIEF DESCRIPTION OF THE DRAWINGS

FIG. 1 is a block diagram showing a detailed arrangement of a multimedia information playback apparatus according to the first embodiment of the present invention;

FIG. 2 is a block diagram for explaining the function of the multimedia information playback apparatus;

FIG. 3 is a block diagram for explaining the function of the multimedia information playback apparatus;

FIG. 4 is a flow chart for explaining processing (switching processing) of switching the playback mode in a DVD-ROM according to the first embodiment;

FIG. 5 is a block diagram for explaining the function of a multimedia information playback apparatus according to the second embodiment of the present invention;

FIG. 6 is a block diagram for explaining the function of the multimedia information playback apparatus according to the second embodiment;

FIG. 7 is a view showing a system according to the third embodiment of the present invention;

FIG. 8 is a view showing another system according to the third embodiment of the present invention;

FIG. 9 is a block diagram showing a multimedia information playback apparatus according to the third embodiment of the present invention;

FIG. 10 is a flow chart showing the operation of the third embodiment;

FIG. 11 is a flow chart showing the operation of the third embodiment;

FIG. 12 is a flow chart showing the operation of the third embodiment;

FIG. 13 is a flow chart showing the operation of the third embodiment;

FIG. 14 is a flow chart showing the operation of the third embodiment;

FIG. 15 is a view showing a system according to the fourth embodiment of the present invention;

FIG. 16 is a view showing another system according to the fourth embodiment of the present invention;

FIG. 17 is a block diagram showing a network server according to the fourth embodiment of the present invention;

FIG. 18 is a flow chart showing the operation of the fourth embodiment;

FIG. 19 is a flow chart showing the operation of the fourth embodiment;

FIG. 20 is a flow chart showing the operation of the fourth embodiment; and

FIG. 21 is a flow chart showing the operation of the fourth embodiment.

### DESCRIPTION OF THE PREFERRED EMBODIMENTS

The present invention will be described below with reference to the accompanying drawings.

### First Embodiment

A multimedia information playback apparatus according to the first embodiment can play back video and audio contents in a VOB file as multimedia information, and can also switch a playback mode in playback. The playback mode includes the first and second playback modes. In the first playback mode, the multimedia information playback apparatus analyzes control information recorded on a DVD-ROM, and controls read of multimedia information. Note that analysis and read control of control information are done by a program (to be referred to as a first navigator hereinafter) in the multimedia information playback apparatus. In the second playback mode, the multimedia information playback apparatus controls read of multimedia information in accordance with a program (to be referred to as a second navigator hereinafter) set based on data received from an external server. In switching the playback mode, the multimedia information playback apparatus performs authentication with the external server present outside the apparatus.

The first navigator is a program for analyzing control information recorded on a DVD-ROM, i.e., a command in an IFO file or a command necessary for read control, and outputting as an instruction a read control request of controlling a device in reading out multimedia information recorded on the DVD-ROM. The command necessary for read control includes, e.g., the pre-command and post-command of a program chain. Unlike the first navigator, the second navigator outputs a control request without analyzing control information such as a command in an IFO file, and has pseudo control information (to be described later) as program data.

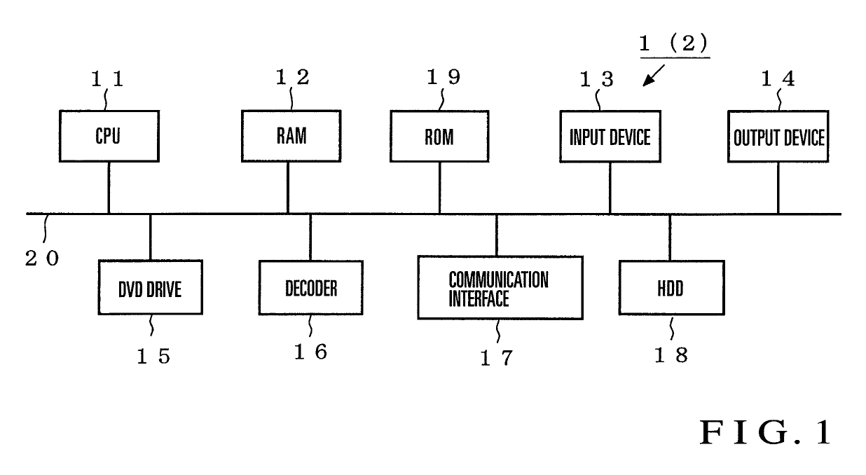

The present invention can be implemented by a computer. A case wherein the present invention is implemented by a computer will be exemplified. As shown in FIG. 1, a multimedia information playback apparatus 1 comprises a CPU 11, memories (RAM 12 and ROM 19), input device 13, output device 14, DVD drive 15, decoder 16, communication interface 17, and HDD (Hard Disk Drive) 18. The respective devices are connected via a bus line 20 to the CPU 11 for controlling the overall apparatus.

The DVD drive 15 reads out various pieces of information recorded on a DVD-ROM (not shown) under the control of the CPU 11. Of pieces of readout information, a VOB file as multimedia information is decoded by the decoder 16, and sent to the output device serving as a display for displaying a picture or a loudspeaker for outputting a sound. The decoder 16 serving as a first decoding unit decodes compressed data (in, e.g., the MPEG2 format) in a VOB file. Note that the multimedia information playback apparatus 1 may be constituted by replacing the decoder 16 as a device with a program for decoding data read out from the HDD 18 to the RAM 12.

The HDD 18 holds computer-readable data such as various files and applications in the apparatus. The input device 13 includes a keyboard, mouse, and push buttons through which the user inputs an instruction to the apparatus. The ROM 19 stores various data necessary for basic processing operation.

The communication interface 17 performs communication with an Internet/intranet server (to be referred to as an external server hereinafter) outside the apparatus, and is formed using, e.g., a modem or LAN adapter. The modem performs modulation/demodulation processing in communicating with an external apparatus via a telephone line or the like. The LAN adapter is an interface for communicating with another apparatus within a LAN or an apparatus within another network connected to the LAN.

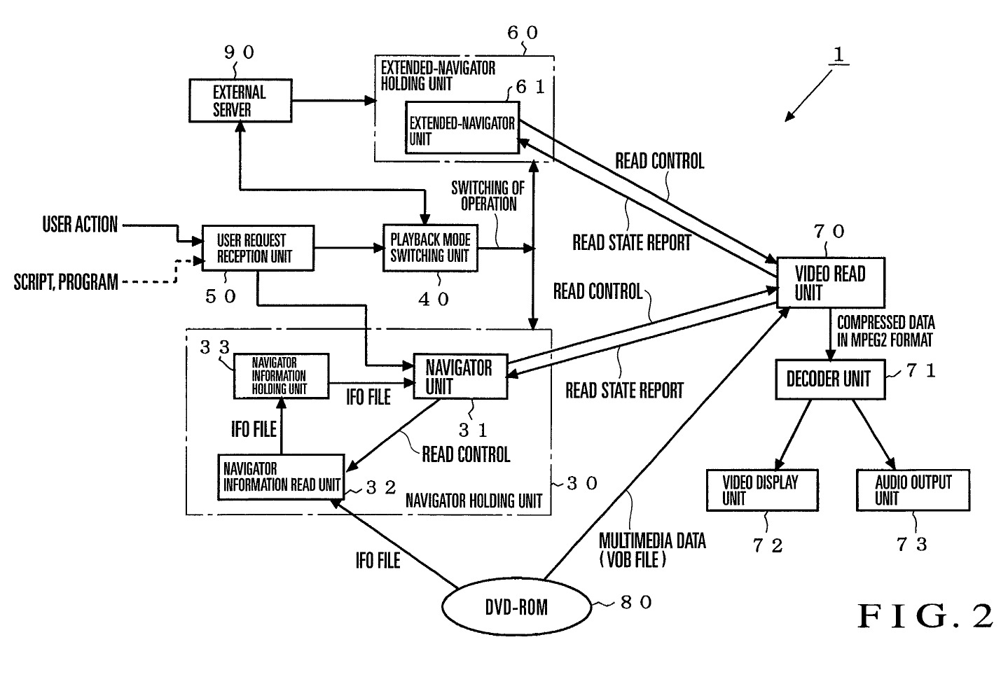

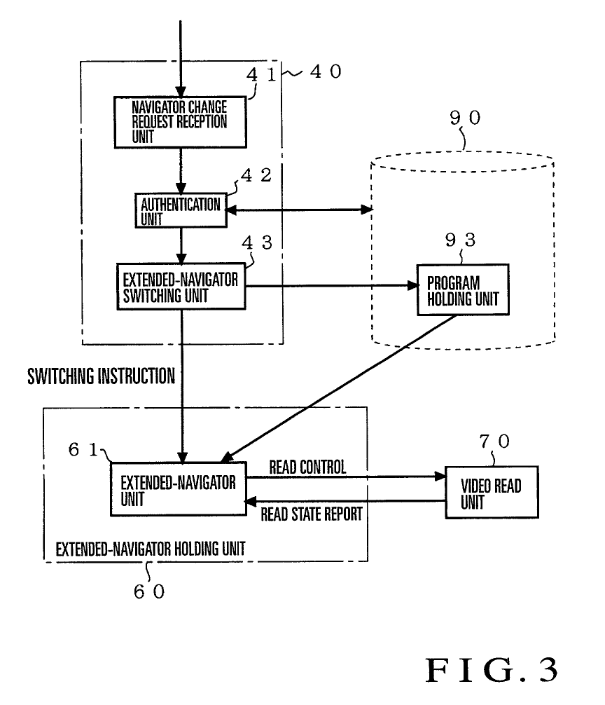

FIGS. 2 and 3 show the functional arrangement of the multimedia information playback apparatus 1. As shown in FIG. 2, the multimedia information playback apparatus 1 comprises a navigator holding unit 30, playback mode switching unit 40, user request reception unit 50, video read unit 70, decoder unit 71, video display unit 72, and audio output unit 73. The navigator holding unit 30 is constituted by the CPU 11, RAM 12, and ROM 19. In the first playback mode, the navigator holding unit 30 holds a program for operating the CPU 11, i.e., the first navigator, reads out an IFO file or the like recorded on a DVD-ROM 80 in advance, analyzes the contents, and performs read control of the video read unit 70.

For this purpose, the navigator holding unit 30 has a navigator unit 31, navigator information read unit 32, and navigator information holding unit 33, as shown in FIG. 2. The navigator unit 31 holds a program necessary for playing back a picture or the like in the first playback mode. The navigator unit 31 analyzes an IFO file or the like in cooperation with the CPU 11 and a program stored as the navigator unit 31 in the RAM. The navigator unit 31 also analyzes a command necessary for read control, and outputs a control request to the DVD drive 15 serving as the video read unit 70.

Note that a program held by the navigator unit 31 is read out from the HDD 18, and mapped in the RAM 12 before processing by the CPU 11. In the following description, “playback” means processing of performing read control of a VOB file and playing back a picture and sound on the basis of control information such as an IFO file recorded on the DVD-ROM 80 in advance in accordance with the DVD standard or a command necessary for read control in the first playback mode.

In performing read control, the CPU 11 receives from the DVD drive 15 a read state report sent from the video read unit 70, e.g., a command such as a readout pre-/post-command necessary for read control, positional information of compressed data in a DVD that is to be read, or information about the read length or the like necessary for read control. When the navigator information read unit 32 receives an IFO file read request under read control of the navigator unit 31, the navigator information read unit 32 searches the DVD-ROM 80 to read out an IFO file. For example, the DVD drive 15 reads out an IFO file.

Note that the readout IFO file is sent from the navigator information read unit 32 to the RAM 12 serving as the navigator information holding unit 33 where the IFO file is held. The playback mode switching unit 40 shown in FIG. 2 switches the playback mode in accordance with a playback mode switching request as a user action, and performs playback mode switching processing in cooperation with the CPU 11 and a change program stored in the RAM 12. The change program is read out from the HDD 18, and mapped in the RAM 12 in processing by the CPU 11. In switching the playback mode, the playback mode switching unit 40 outputs to an external server 90 a request of loading a program for performing authentication processing with the external server 90 or for causing the CPU 11 to execute the second playback mode.

For this purpose, the playback mode switching unit 40 has a navigator change request reception unit 41, authentication unit 42, and extended-navigator switching unit 43, as shown in FIG. 3. The navigator change request reception unit 41 recognizes a signal (to be referred to as a switching request signal) which is sent from the user request reception unit 50 to request switching. When the navigator change request reception unit 41 receives a switching request signal, it sends to the authentication unit 42 a signal which requests the start of authentication processing. In this case, the CPU 11 recognizes the switching request signal, and starts authentication processing.

The authentication unit 42 performs mutual authentication with the external server 90. Mutual authentication is performed such that the authentication unit 42 sends a key code to the external server 90, checks the response of the external server 90 to recognize whether the external server 90 is an authentic external server, receives a key code from the external server 90, sends the response with respect to the key code, and confirms with the external server 90 whether they communicate with proper partners. Then, if the authentication unit 42 receives from the external server 90 a signal representing “OK” as a result of authentication, the authentication unit 42 sends a signal representing this to the extended-navigator switching unit 43. The extended-navigator switching unit 43 outputs to a program holding unit 93 in the external server 90 a request of loading a program (second navigator) for performing the second playback mode. Note that the program holding unit 93 in the external server 90 holds a program to be transmitted to an extended-navigator holding unit 60.

The extended-navigator switching unit 43 supplies a switching instruction to a program for operating the CPU 11 in the second playback mode that is loaded from the external server 90 and mapped in the extended-navigator holding unit 60, i.e., RAM 12, which will be described later. By this switching instruction, the playback mode is switched from the first playback mode to the second one. If mutual authentication is not normally done in the authentication unit 42, no program is loaded.

The loaded program is made up of an execution program for executing the program itself, and a command (to be referred to as pseudo control information hereinafter) for playing back a VOB file in a DVD-ROM that is contained in the execution program. As the command, information necessary for read control of compressed data to be read out from the DVD-ROM is described. The pseudo control information is processed while the program is executed, but output as a control request to the video read unit 70 without any analysis. The execution program does not analyze a pre-/post-command, unlike a program held in the navigator unit 31.

Note that pseudo control information includes positional information of compressed data in a DVD, information about the read length or the like necessary for read control, and in addition a program for displaying a menu for causing the user to perform predetermined processing.

The multimedia information playback apparatus may execute playback mode switching processing without performing authentication processing.

The extended-navigator holding unit 60 shown in FIG. 2 holds a loaded program. In playing back the DVD-ROM 80, the extended-navigator holding unit 60 performs read control of the video read unit 70 in order to read out a VOB file stored in the DVD-ROM 80 in a playback order different from that in normal playback, as the second playback mode.

The extended-navigator holding unit 60 performs playback control regardless of the DVD standard, and does not use any control information in the DVD-ROM 80 in playback. In the following description, “extended playback” means playback of a picture or the like in the second playback mode. Note that the address areas of the RAM 12 used by the extended-navigator holding unit 60 and navigator holding unit 30 do not overlap each other.

For this purpose, the extended-navigator holding unit 60 has an extended-navigator unit 61, as shown in FIG. 2. The extended-navigator unit 61 holds a loaded program. The CPU 11 executes a program held in the RAM 12 serving as the extended-navigator unit 61, and then a control request, i.e., pseudo control information is sent to the video read unit 70.

The video read unit 70 is formed using the DVD drive 15. In normal playback, the video read unit 70 reads out compressed data in a VOB file from the DVD-ROM 80, and transmits the readout data to the decoder unit 71. In addition, the video read unit 70 transmits to the navigator unit 31 positional information of compressed data in a DVD that is to be read, or information about the read length or the like necessary for read control.

In extended playback, the video read unit 70 reads a VOB file, and transmits positional information of compressed data in a DVD that is to be read, or information about the read length or the like necessary for read control under the read control of the second navigator. The decoder unit 71 corresponds to the decoder 16, whereas the video display unit 72 and audio output unit 73 correspond to the output device 14.

The user request reception unit 50 receives a user request and switching request, distributes the user request to either one of the extended-navigator holding unit 60 and navigator holding unit 30, and sends the switching request to the playback mode switching unit 40. The user request reception unit 50 is made up of the CPU 11 and the RAM 12 or ROM 19 for holding a program for identifying a signal sent as a user action.

In this case, the user request is a request signal for playback, stop, pause, audio switching, or the like in playing back a picture in the DVD-ROM 80. The user request and switching request are generated by operating, e.g., a button, keyboard, mouse, or remote controller. These requests are distributed by the user request reception unit 50 on the basis of the difference in the number of bits or bit code.

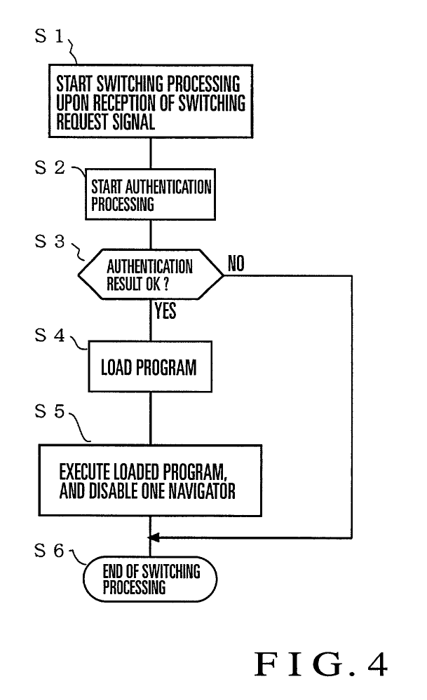

The operation of the multimedia information playback apparatus 1 described above in detail according to the first embodiment will be explained with reference to the flow chart of FIG. 4. If the CPU 11 recognizes a switching request signal generated as a user action, playback mode switching processing starts (step S1). The CPU 11 starts processing of confirming mutual authentication with an external server (steps S2 and S3). At this time, the CPU 11 controls the communication interface 17 in order to transmit an authentication key code to the external server present in the Internet or an intranet or receive a response. If the CPU 11 receives an appropriate authentication result (OK), it controls the communication interface 17, and outputs to the external server 90 a request of loading a program to be executed in the second playback mode.

If the program has been loaded (step S4), the CPU 11 executes the loaded program, and stores it in an area different from a memory area where a program or the like used in the first playback mode is mapped (step S5). In executing the loaded program, the CPU 11 disables an existing program, i.e., program used in the first playback mode (step S5). Then, switching processing ends (step S6). If the authentication result is NG in step S3, the CPU 11 does not load any program, and ends switching processing (step S6).

Extended playback will be explained. When the CPU 11 recognizes a signal which requests execution of extended playback generated as a user action, the CPU 11 outputs to the DVD drive 15 pseudo control information assembled in the loaded program, such as positional information of compressed data in the DVD-ROM 80 that is to be read out.

In executing the program, the CPU 11 displays, e.g., a button command for requesting a user instruction representing whether to skip to a different frame. Readout compressed data is decoded by the decoder 16, and output as a picture or sound from the output device 14.

In the multimedia information playback apparatus 1 of the first embodiment, the navigator is switched after authentication processing to control playback of the DVD-ROM. The multimedia information playback apparatus 1 can prevent a situation in which playback control different from that based on control information recorded on the DVD-ROM 80 is performed using a copied or tampered IFO file. When the authentication result is NG, switching of the navigator can be stopped, thereby inhibiting illicit switching of the navigator.

The multimedia information playback apparatus 1 plays back a picture without interpreting an IFO file or a command necessary for read control. Accordingly, the multimedia information playback apparatus 1 can perform playback different from playback complying with the DVD standard within a range set by a program executed in the second playback mode, i.e., pseudo control information. Since the second navigator does not remain in the RAM 12 or the like after extended playback, the multimedia information playback apparatus 1 can reliably prevent copying or the like.

### Second Embodiment

A multimedia information playback apparatus according to the second embodiment will be described. Unlike the multimedia information playback apparatus 1 according to the first embodiment, the multimedia information playback apparatus according to the second embodiment reads out compressed data from a DVD-ROM on the basis of an instruction sent from an external server in real time.

In the multimedia information playback apparatus 1 of the first embodiment, a program loaded from the external server 90 is held by the extended-navigator unit 61, and the CPU 11 outputs pseudo control information contained in the program as a control request to the video read unit 70 during execution of the program. In the second embodiment, this pseudo control information is sent as an instruction from the external server. That is, read control of compressed data is done in accordance with an instruction sent from the external server.

As shown in FIGS. 1, 5, and 6, a multimedia information playback apparatus 2 of the second embodiment has almost the same arrangement as that in the first embodiment. Note that the same reference numerals denote the same parts, and a description thereof will be omitted.

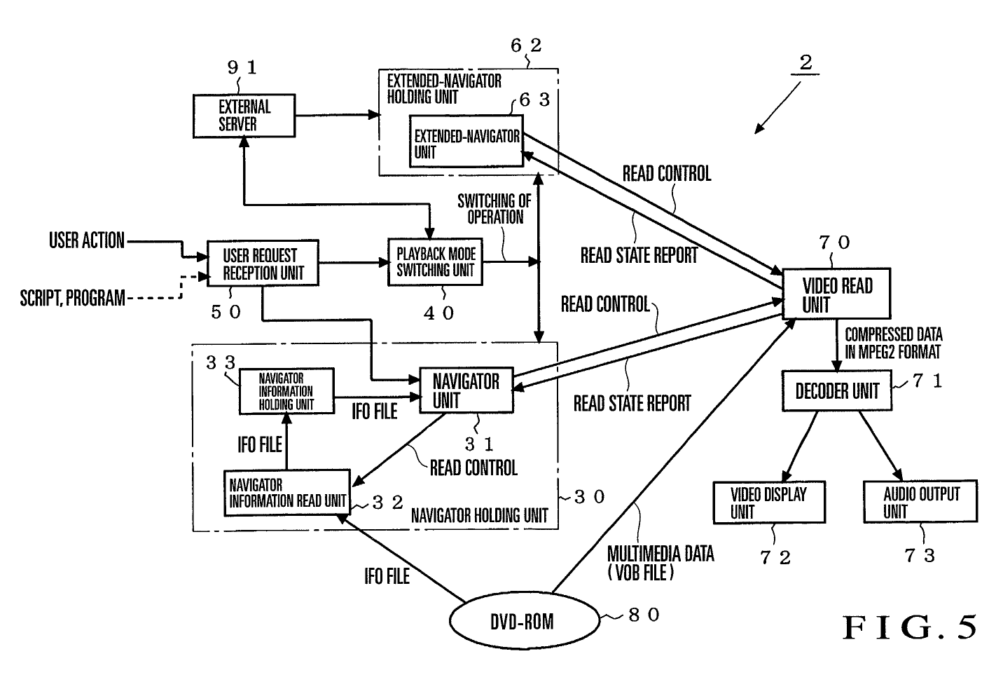

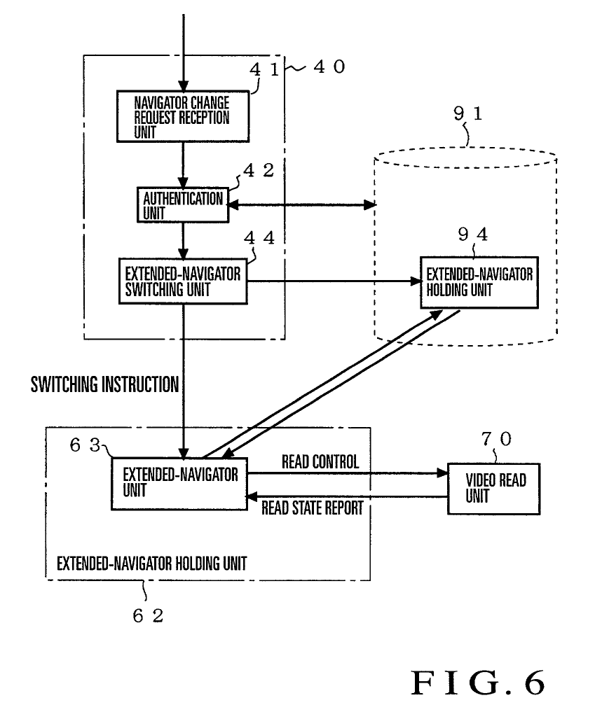

As shown in FIG. 5, the multimedia information playback apparatus 2 incorporates an extended-navigator holding unit 62 in place of the extended-navigator holding unit 60 (see FIG. 2). As shown in FIG. 6, a playback mode switching unit 40 comprises an extended-navigator switching unit 44 instead of the extended-navigator switching unit 43 (see FIG. 3), whereas an external server 91 comprises an extended-navigator holding unit 94.

The extended-navigator holding unit 62 shown in FIG. 5 relays an instruction sent from the external server 91 to a video read unit 70, and relays a read state report sent from the video read unit 70. In relaying an instruction or the like, the extended-navigator holding unit 62 temporarily holds the instruction or the like.

The extended-navigator holding unit 62 further comprises an extended-navigator unit 63. The extended-navigator unit 63 holds a program (second navigator), similar to the extended-navigator unit 61 of the first embodiment. By processing the program held in the extended-navigator unit 63 by a CPU 11, an instruction or the like is relayed, and the video read unit 70 is controlled upon reception of a request about playback, stop, skip, or the like as a user action. The second navigator in the second embodiment does not contain pseudo control information in the program, unlike the second navigator of the first embodiment.

The program as the second navigator is read out from an HDD 18 by the CPU 11, and mapped in a RAM 12. The read timing from the HDD 18 to the RAM 12 is, e.g., at the start of the apparatus or when a playback mode switching unit 40 receives a switching request signal.

When a held program is executed in an extended-navigator unit (not shown) in the extended-navigator holding unit 94 shown in FIG. 6, an instruction representing, e.g., positional information of compressed data in a DVD-ROM 80 that is to be read out from the DVD-ROM 80 is transmitted from the external server 91 to the multimedia information playback apparatus 2.

The extended-navigator switching unit 44 shown in FIG. 6 sends an operation switching instruction to the extended-navigator unit 63 of the extended-navigator holding unit 62 when authentication processing normally ends. The extended-navigator switching unit 44 is made up of the CPU 11 and RAM 12. Upon reception of the operation switching instruction, the CPU 11 processes the program held in the extended-navigator unit 63 as a program to be processed in the second playback mode.

The extended-navigator holding unit 94 of the external server 91 sends pseudo control information in the second playback mode. Although not shown, the transmission start timing is, e.g., upon reception of a request (request signal for sending pseudo control information) from the extended-navigator holding unit 62. Note that the extended-navigator holding unit 94 refers to a read state report sent received from the multimedia information playback apparatus 2, and sends, as a control request, information which designates compressed data to be read out next.

Similar to switching processing in the first embodiment, authentication processing is executed between the multimedia information playback apparatus 2 and the external server 91. After that, the external server 91 receives pseudo control information transmission request from the multimedia information playback apparatus 2, and starts transmission. In the multimedia information playback apparatus 2, the extended-navigator holding unit 62 receives pseudo control information sent from the external server 91, sends it to the video read unit 70 where compressed data is read out.

The multimedia information playback apparatus 2 according to the second embodiment reads out compressed data in real time upon reception of an externally sent control request. Similar to the effects of the first embodiment, the multimedia information playback apparatus 2 can perform control not complying with the DVD standard, and can prevent a situation in which playback control different from that based on control information recorded on a DVD-ROM is performed using a tampered or copied IFO file. Moreover, the multimedia information playback apparatus 2 according to the second embodiment executes playback control on the basis of a control request sent from the external server 91. For example, when read of predetermined compressed data ends, pseudo control information for reading out the compressed data is not held. Thus, copying or the like can be reliably prevented.

In the multimedia information playback apparatus 2 of the second embodiment, the external server 91 substantially performs read control processing, thereby distributing processing. The internal resource (memory capacity or CPU performance) of the multimedia information playback apparatus 2 can be saved.

In the multimedia information playback apparatus 2 of the second embodiment, a program held in the extended-navigator unit 63 is read out from the HDD 18 in switching the playback mode. Similar to a program held in the extended-navigator unit 61 according to the first embodiment, the program may be loaded from the external server 91 after authentication processing. In loading a program to be held in the extended-navigator unit 63 from the external server 91, the extended-navigator switching unit 44 shown in FIG. 6 sends a loading request to the external server 91.

Also in the second embodiment, the multimedia information playback apparatus 2 may switch the playback mode without performing authentication processing.

In the above description, the first playback mode is switched to the second playback mode. The multimedia information playback apparatus 1 or 2 may switch the second playback mode to the first playback mode. Note that in switching to the first playback mode, authentication operation with the external server 90 or 91 is omitted.

The multimedia information playback apparatus comprises the video display unit serving as an output unit, and the output device serving as an audio output unit. The multimedia information playback apparatus is not limited to them, and may comprise an output means (e.g., output terminal) for simply externally outputting video and audio signals and use an external video display unit and audio output unit. The first and second embodiments have exemplified a computer, but the present invention can be implemented as a player dedicated to playback of multimedia information that is constituted similarly to the above apparatus. When the present invention is to be implemented as a player, e.g., it is possible to omit the output device and HDD 18 from the arrangement shown in FIG. 1, and adopt an output means.

In the first and second embodiments, a program or control request processed by the CPU 11 in the second playback mode may be encrypted and communicated between the external server 90 or 91 and the multimedia information playback apparatus 1 or 2. In this case, the multimedia information playback apparatus 1 or 2 comprises a decoder (decoder different from the decoder 16 shown in FIG. 1) serving as the second decoder unit for decrypting encrypted information, in addition to the above-described arrangement. The external server 90 or 91 comprises an encoder.

By attaching temporal information to a loaded program or a key code in authentication processing, the multimedia information playback apparatus 1 or 2 can inhibit playback. For example, the multimedia information playback apparatus 1 or 2 acquire time & date information indicated by the timer of the external server, and when the timer value passes the due time and date (temporal information) contained in the program, the multimedia information playback apparatus 1 or 2 inhibits playback. Determination of whether to inhibit playback on the basis of temporal information is executed by the playback mode switching unit 40 or the extended-navigator holding unit 60 or 62.

In the first and second embodiments, the CPU 11 may execute a program held in the extended-navigator unit 61 or 63, and confirm whether the program loaded from the external server 90 or 91 is not illicitly copied. For example, the apparatus itself has information (confirmation information) for confirming whether a loaded program is legal, and information corresponding to the confirmation information is contained in the program. Whether the program is legal is checked while the CPU 11 processes the program. If the confirmation information is determined not to be legal, the playback mode is not switched. This determination is done by the playback mode switching unit 40 or the extended-navigator holding unit 60 or 62.

In the above description, the multimedia information playback apparatus 1 or 2 performs read control in the first or second playback mode. Alternatively, the multimedia information playback apparatus 1 or 2 may perform read control only in the second playback mode. In this case, the multimedia information playback apparatus 1 or 2 shown in FIG. 2 or 5 does not comprise the navigator holding unit 30.

In the above description, the playback mode is switched, e.g., upon reception of a user request. However, switching of the playback mode depends on the script or program, and is executed at various timings.

For example, the playback mode is switched:

(1) Unconditionally when the user performs predetermined operation, e.g., when a menu asking whether to execute extended playback is displayed in the pre- or post-command of PGC, and selected by the user;

(2) When the multimedia information playback apparatus is turned on, and a menu asking whether to execute extended playback is displayed and selected by the user; or

(3) When a script or program is input outside the multimedia information playback apparatus, e.g., when a script or program represented by the dotted line in FIG. 2 or 5 is input as a switching request signal instead of a change request signal generated by operating the keyboard or the like by the user within a user action.

In case (3), the playback mode is automatically switched without any confirmation by the user.

### Third Embodiment

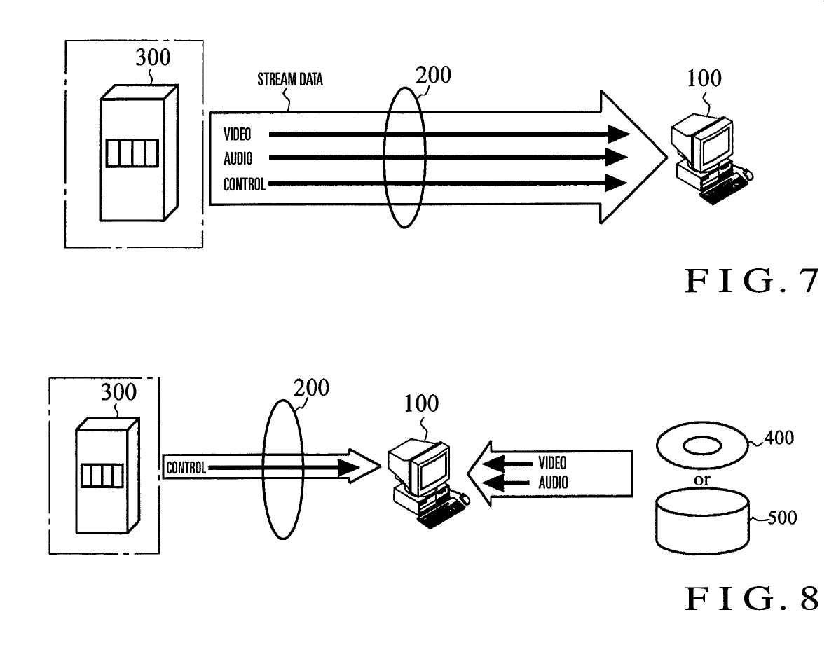

FIG. 7 shows the third embodiment. In FIG. 7, reference numeral 100 denotes a stream data playback apparatus (network client) for playing back stream data as multimedia information; 200, a network including a network for distributing digital broadcasting and a network such as a local area network or the Internet; and 300, a network server (to be referred to as a server hereinafter). As shown in FIG. 7, stream data contains video data, audio data, and control data (to be also referred to as control information hereinafter) for controlling playback of these data.

Control data has functions of limiting playback contents, e.g., a user operation limitation function, playback channel limitation function (when the digital broadcasting has a plurality of channels), playback stream data limitation function, and a function of checking user operation and playing back a stream.

Such stream data is obtained when video data, audio data, or control data are distributed from the server 300 to the stream playback apparatus 100 via the network 200, as shown in FIG. 7, or when only control data is distributed from the server 300, and video data and audio data are distributed from a DVD 400 (including a CD-ROM) or another storage device 500, as shown in FIG. 8.

The distributed stream data is received by and stored in the stream playback apparatus 100. The stored stream data can also be stored as encoded or masked data so as not to directly play back it.

Examples of the masking method are

(1) To exchange a stream ID,

(2) To invalidate the channel number,

(3) To mask color information of video data, and

(4) To mask audio data.

The masked stream data is decoded or its masking is canceled before playback.

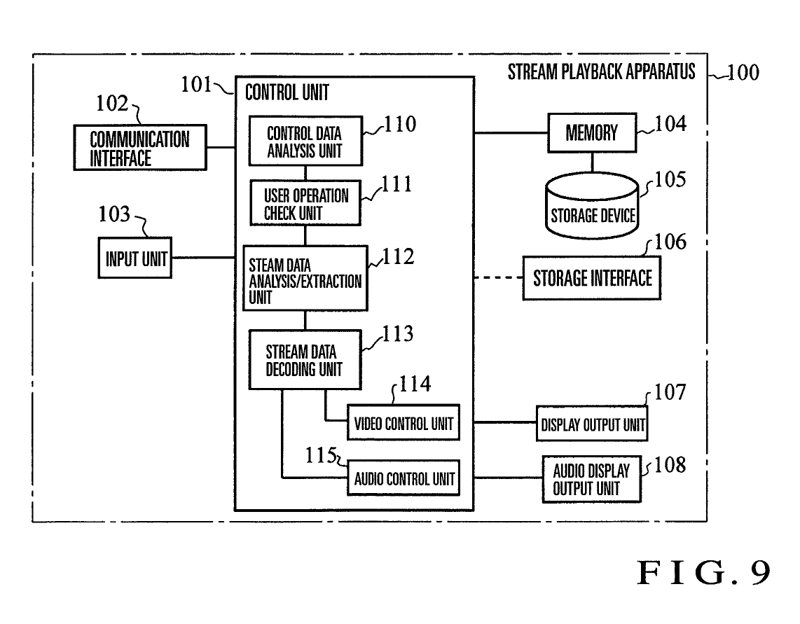

FIG. 9 shows the arrangement of the stream data playback apparatus 100 for playing back stream data.

The stream data playback apparatus 100 is constituted by a control unit 101 for controlling the whole apparatus, a communication interface 102 for communicating with the server 300 via the network 200, an input unit 103 for inputting user operation, a memory (memory buffer) 104 for storing control data or the like, a storage device 105 such as a disk for storing distributed video and audio data, a storage interface 106 for inputting video and audio data from the DVD or CD-ROM 400 or the storage device 500 such as a digital video or hard disk, a display output unit 107 such as a display for displaying video display, and an audio display output unit 108 such as a loudspeaker for outputting an audio signal (voice-band signal).

The control unit 101 comprises a control data analysis unit 110 for analyzing input control data, a user operation check unit 111 for checking a user operation input via the input unit 103, a steam data analysis/extraction unit 112 for analyzing and extracting input stream data, a stream data decoding unit 113 for decoding the extracted stream data, a video control unit 114 for outputting video data decoded by the stream data decoding unit 113 to the display output unit 107, which plays back and displays the video data, and an audio control unit 115 for outputting audio data (audio range data) decoded by the stream data decoding unit 113 to the display output unit 107, which outputs the audio data.

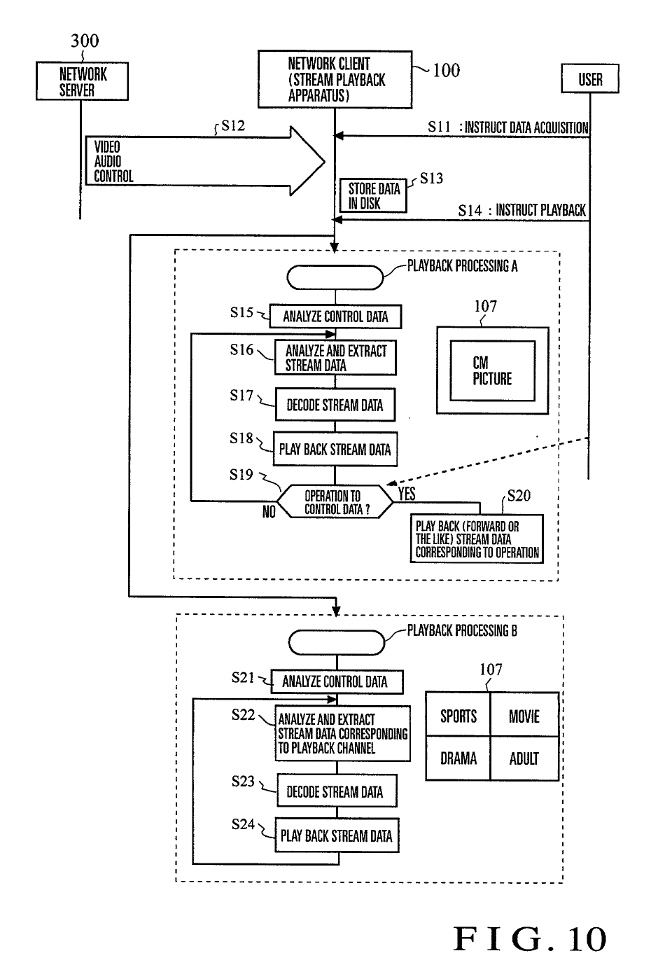

The operation of the control unit 101 of the stream data playback apparatus 100 having this arrangement will be explained with reference to FIGS. 10 to 14.

An operation flow shown in FIG. 10 will be explained. If user operation instructs data acquisition (step S11), the control unit 101 of the stream data playback apparatus 100 (to be referred to as the playback apparatus 100 hereinafter) acquires video, audio, and control data distributed from the server 300 (step S12), and stores them in a disk serving as the storage device 105 (step S13). If user operation instructs playback (step S14), the control unit 101 of the playback apparatus 100 reads out the control data stored in the disk, and performs playback processing of the video and audio data in the disk in accordance with the control data.

In playback processing A of FIG. 10, the control unit 101 of the playback apparatus 100 analyzes the control data (step S15), and analyzes and extracts the video and audio data as stream data in accordance with the analysis result (step S16). The control unit 101 decodes the extracted video and audio data (step S17), and plays back these stream data (step S18). If user operation is done during playback of the stream data, the playback apparatus 100 determines in step S19 whether the user operation is to change the control data. The playback apparatus 100 determines “Y” in step S19 if the frame of the played picture is, e.g., a CM (Commercial Message) at present, the user operation is control data change operation so as to forward the CM frame and play back the next picture, and the user is not a subscriber who cannot forward the CM picture.

In this case, the control unit 101 of the playback apparatus 100 plays back stream data corresponding to the control data changed based on the user change operation (step S20). Note that when the user makes subscription which inhibits fast forwarding of the CM picture, the control unit 101 of the playback apparatus 100 ignores the user operation of changing the control data, returns to step S16, and subsequently plays back and displays the CM picture.

Also in playback processing B of FIG. 10, the control unit 101 of the playback apparatus 100 similarly analyzes the control data (step S21). In playback processing B, stream data distributed from the server 300 via the network 200 is stream data of the digital broadcasting. In this case, the control unit 101 analyzes and extracts stream data of a playback enable channel corresponding to control data (step S22). The control unit 101 decodes the extracted video and audio data (step S23), and plays back these stream data (step S24). That is, in playback processing B, control data is set in advance so as to inhibit playback of an adult channel among a plurality of channels, and stream data of other channels are played back. If control data is set to data which can control a viewable channel in accordance with the subscription contents, stream data of the channel corresponding to the subscription contents is played back.

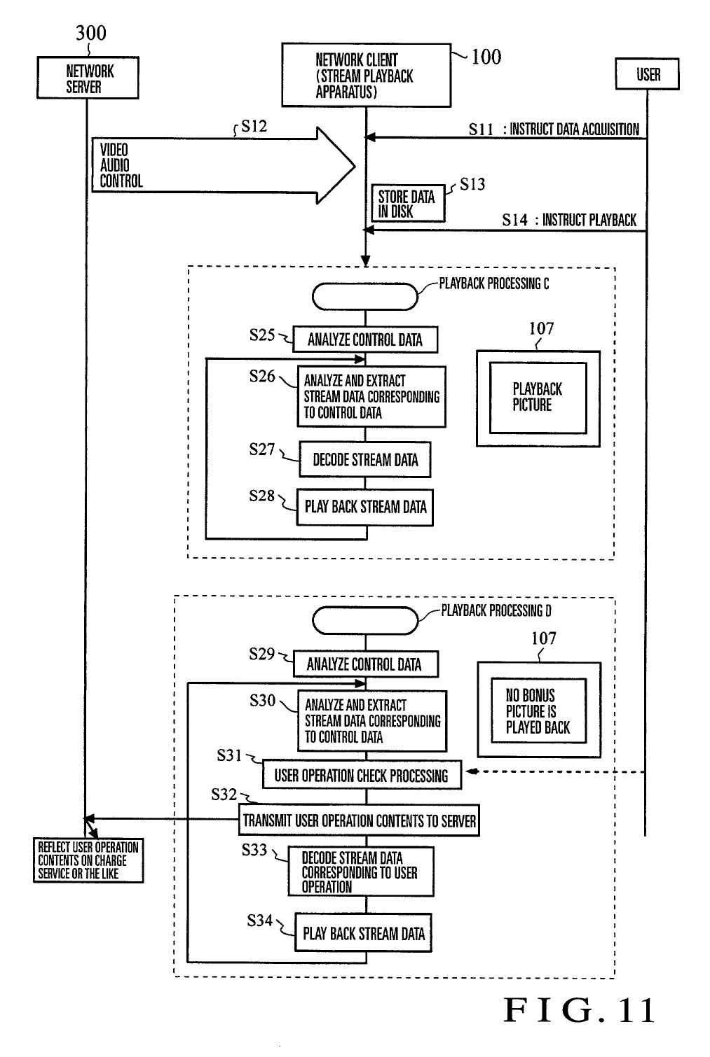

Also in playback processing C of FIG. 11, the control unit 101 of the playback apparatus 100 similarly analyzes the control data (step S25). The control unit 101 analyzes and extracts stream data corresponding to the control data (step S26), decodes the extracted video and audio data (step S27), and plays back these stream data (step S28). That is, in playback processing C, control data is set to inhibit playback of stream data of adult and violence scenes among stream data, and stream data except for adult and violence scenes among the stream data are played back. Alternatively, control data can be set to allow only a high-rate subscriber to view a bonus or free picture.

Also in playback processing D of FIG. 11, the control unit 101 of the playback apparatus 100 similarly analyzes the control data (step S29), and analyzes and extracts stream data corresponding to the control data (step S30). In playback processing D, the control data contains a user operation check module (program). In step S31, the control unit 101 executes this module, performs user operation check processing, and transmits the user operation contents to the server 300 (step S32). At the same time, the control unit 101 decodes stream data corresponding to user operation (step S33), and plays back the stream data (step S34). That is, in playback processing D, the user is caused to input, e.g., a password upon reception of a playback instruction from the user. When the password coincides with a predetermined one, pictures including a bonus picture is played back. To the contrary, when the password does not coincide with a predetermined one, no bonus picture is played back. Furthermore, no bonus picture can be played back to a user who performs fast forwarding playback operation or rewind playback operation during playback of a CM picture, and the viewing fee is reduced for a user who does not perform fast forwarding or rewind playback operation during playback of a CM picture.

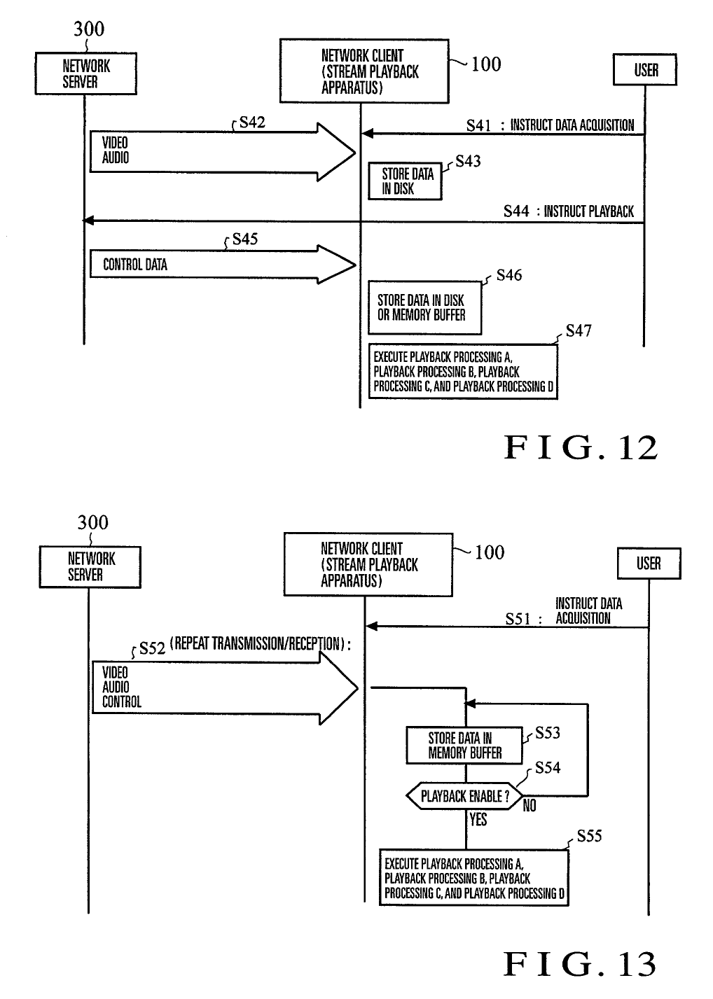

FIGS. 10 and 11 show a case wherein the server 300 distributes video, audio, and control data at once. FIG. 12 shows a case wherein video, audio, and control data are separately distributed.

More specifically, if the user side instructs data acquisition (step S41), the control unit 101 of the playback apparatus 100 receives this instruction, and notifies the server 300 of the instruction. Then, the server 300 distributes video and audio data to the playback apparatus 100 (step S42), and the control unit 101 of the playback apparatus 100 receives them and stores them in a disk (step S43). If the user side instructs playback (step S44), this instruction is transmitted to the server 300, and the control unit 101 of the playback apparatus 100 receives the instruction and stores it in the disk or buffer memory (memory 104) (step S46). The control unit 101 reads out the stored control data, and executes the above-described playback processes A to D of playing back video and audio data in accordance with the control data (step S47).

FIGS. 10 to 12 show a case wherein stream data distributed from the server 300 is stored in the disk or the like of the playback apparatus 100, and then played back. FIG. 13 shows a case wherein stream data are transmitted/received and played back in real time.

More specifically, if the user side instructs playback (step S51), the playback apparatus 100 and server 300 are notified of the playback instruction, and then stream data are transmitted/received between the server 300 and the playback apparatus 100 (step S52). The playback apparatus 100 sequentially stores the stream data from the server 300 in a memory buffer smaller in capacity than the disk (step S53). If the playback apparatus 100 determines that the stream data can be played back (“Y” in step S54), it executes the playback processes A to D of playing back video and audio data in the memory buffer in accordance with control data in the memory buffer (step S55). The playback apparatus 100 performs multitask processing of receiving stream data from the server 300 and storing them in the memory buffer.

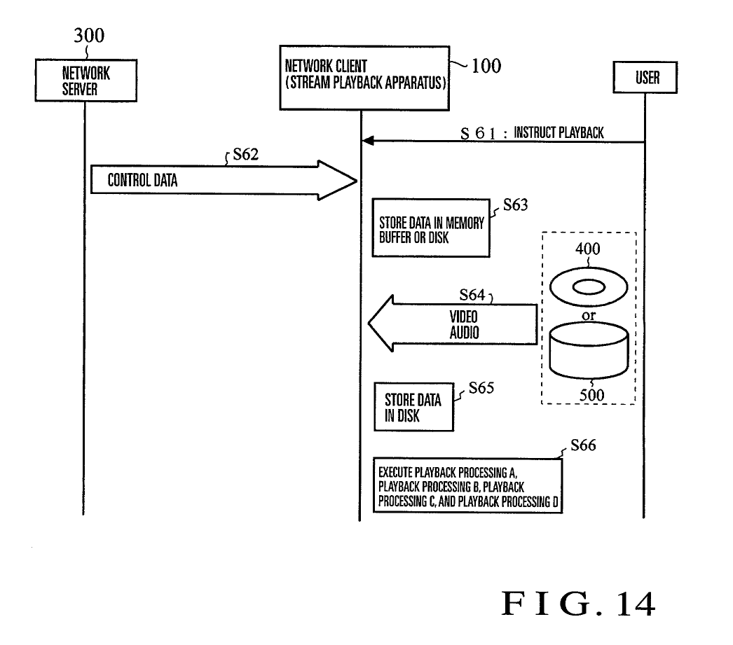

FIG. 14 shows an operation example when control data is distributed from the server 300, and video and audio data are distributed from the DVD 400 or storage device 500, as shown in FIG. 8 described above.

In this arrangement, if the user side instructs playback (step S61), the playback apparatus 100 receives this instruction, and notifies the server 300 of the instruction. Then, the server 300 distributes control data to the playback apparatus 100 (step S62), and the playback apparatus 100 receives the control data and stores it in the memory buffer or disk (step S63). The playback apparatus 100 inputs video and audio data from the DVD 400 or storage device 500, and stores them in the disk (steps S64 and S65). The playback apparatus 100 reads out the stored control data, and executes the playback processes A to D of playing back video and audio data in accordance with the control data (step S66).

### Fourth Embodiment

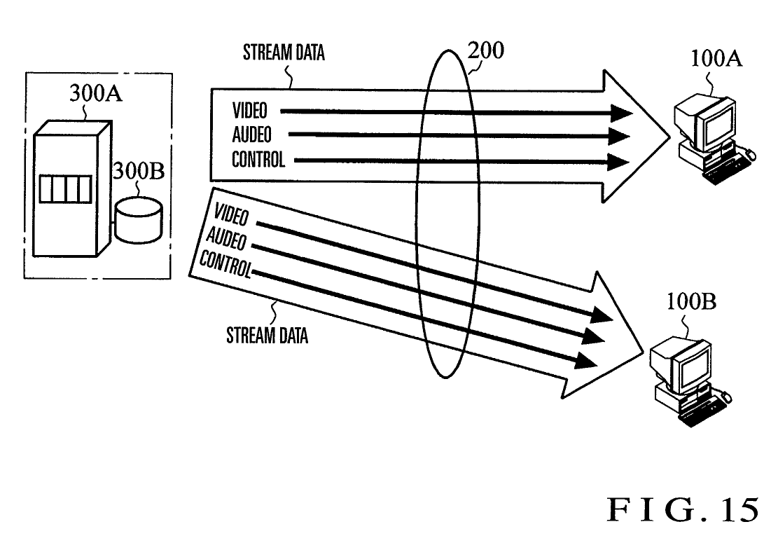

FIG. 15 shows the fourth embodiment. In playing back stream data, the stream data are managed depending on not personal information of the user but group management information corresponding to, e.g., the sex or age of the user.

In FIG. 15, reference symbol 100A denotes a playback apparatus of a user belonging to group A; and 100B, a playback apparatus of a user belonging to group B. A server 300A is connected to a storage unit 300B for storing group management information. The server 300A generates group management information of one group to which a plurality of users having similar personal data belong, and registers the group management information in the storage unit 300B. In addition, the server 300A generates control data for controlling playback of video and audio data on the basis of the group management information in the storage unit 300B.

By managing the user based on the group management information, the data size becomes smaller than in a case wherein data of each user is managed. Personal data of the user can be easily managed.

Since control data can be generated based on the group management information, playback control can be changed for each group.

A group community or the like can be realized using the group management information.

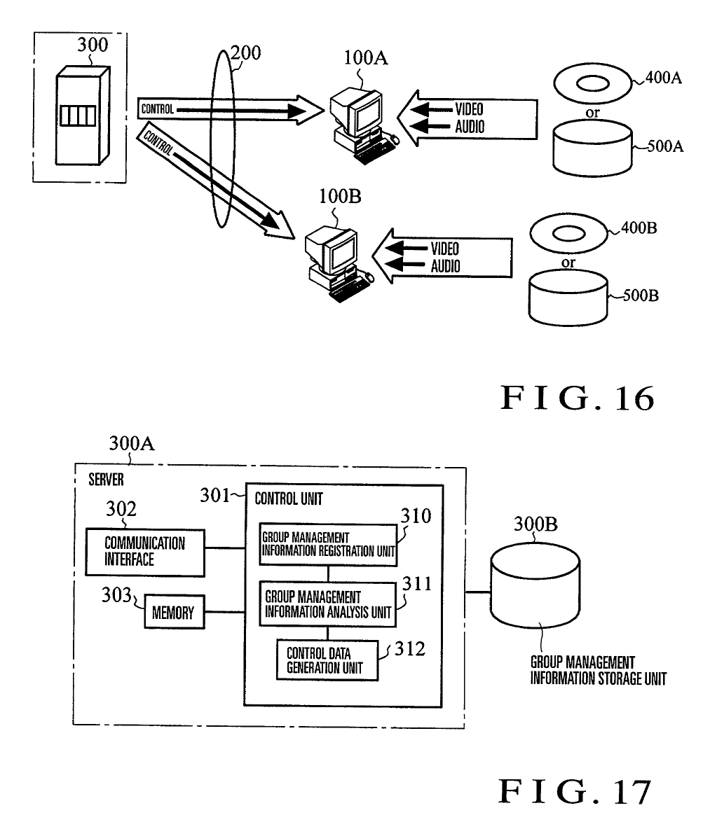

FIG. 16 shows another arrangement when playback of video and audio data is controlled by control data generated based on the above-mentioned group management information. Control data generated based on the group management information is distributed to the playback apparatuses 100A and 100B, whereas video and audio data are distributed from a DVD 400 or storage device 500.

FIG. 17 shows the arrangement of the server 300A. The server 300A is comprised of a control unit 301, a communication interface 302 for communicating with the playback apparatuses 100A and 100B via a network 200, and a memory 303. The control unit 301 is made up of a group management information registration unit 310 for generating group management information on the basis of data input from the user side, and registering it in the storage unit 300B, a group management information analysis unit 311 for analyzing the group management information in the storage unit 300B, and a control data generation unit 312 for generating control data corresponding to the analysis result of the group management information analysis unit 311. Control data generated by the control data generation unit 312 is transmitted to the playback apparatuses 100A and 100B via the communication interface 302 and network 200.

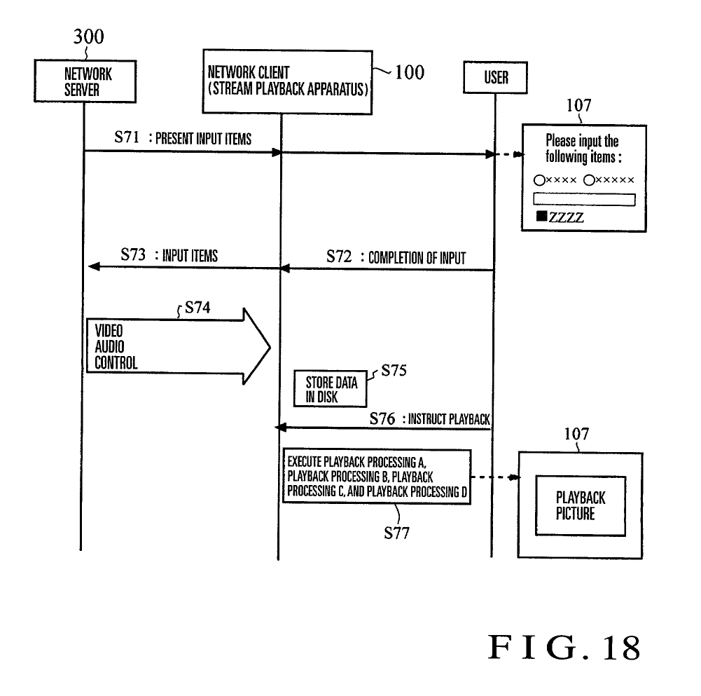

The operation of the fourth embodiment will be explained with reference to FIGS. 18 to 21.

If the server 300 is to generate group management information of the user, the server 300 presents input items in step S71, and causes a display output unit 107 of the playback apparatus 100 to display a user personal information input request window. The user inputs personal information for each item on the input request window display. If the user completes the input (step S72), completion of the input is notified together with the input item data from the playback apparatus 100 to the server 300, which receives the input item data (step S73).

The server 300 generates group management information based on the data input from the user side, generates control data based on the group management information, and distributes the control data together with video and audio data (step S74). The playback apparatus 100 receives the video, audio, and control data distributed from the server 300, and stores them in a disk (step S75). If user operation instructs playback (step S76), the playback apparatus 100 reads out the control data stored in the disk, and executes the playback processes A to D of the video and audio data in the disk on the basis of the control data (step S77).

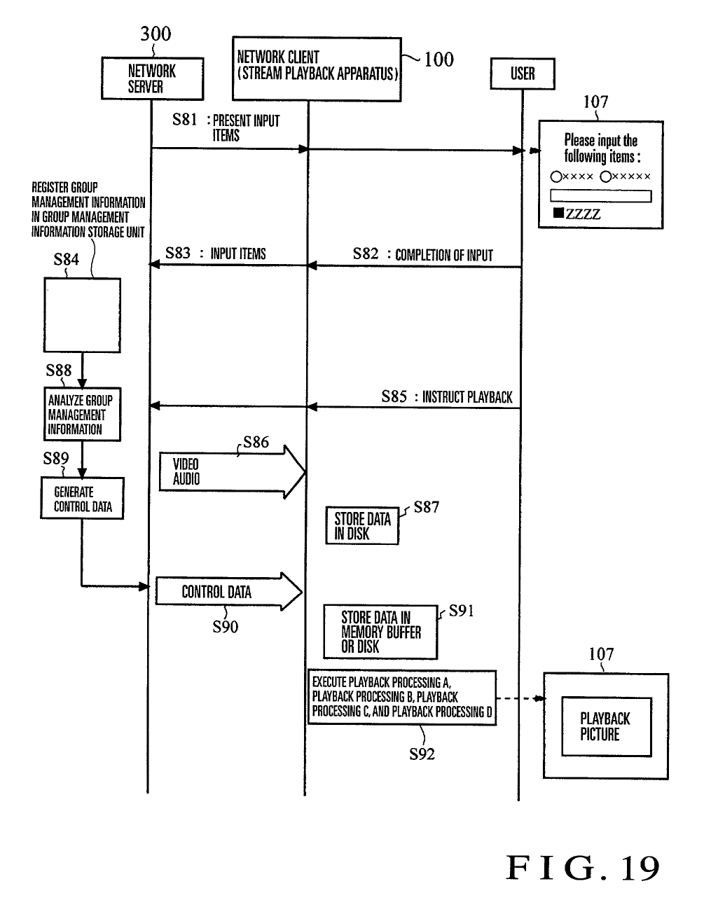

FIG. 19 shows an example in which group management information is generated on the basis of data input from the user side, and control data is generated on the basis of the group management information and distributed to the playback apparatus 100. In the example of FIG. 19, video and audio data, and control data are separately distributed to the playback apparatus 100.

More specifically, similar to FIG. 18, the server 300 presents input items in step S81 of FIG. 19. If the server 300 receives data of the input items from the user side (step S83), it generates group management information based on the input data.

The server 300 registers the generated group management information in the storage unit 300B (step S84). If the user side instructs playback (step S85), the server 300 distributes video and audio data to the playback apparatus 100 (step S86), and the playback apparatus 100 stores them in the disk (steps S86 and S87). Then, the server 300 distributes the generated control data to the playback apparatus 100 (step S90). The playback apparatus 100 stores the control data distributed from the server 300 in the memory buffer or disk (step S91). The playback apparatus 100 reads out the stored control data, and executes the playback processes A to D of the video and audio data in the disk on the basis of the control data (step S92).

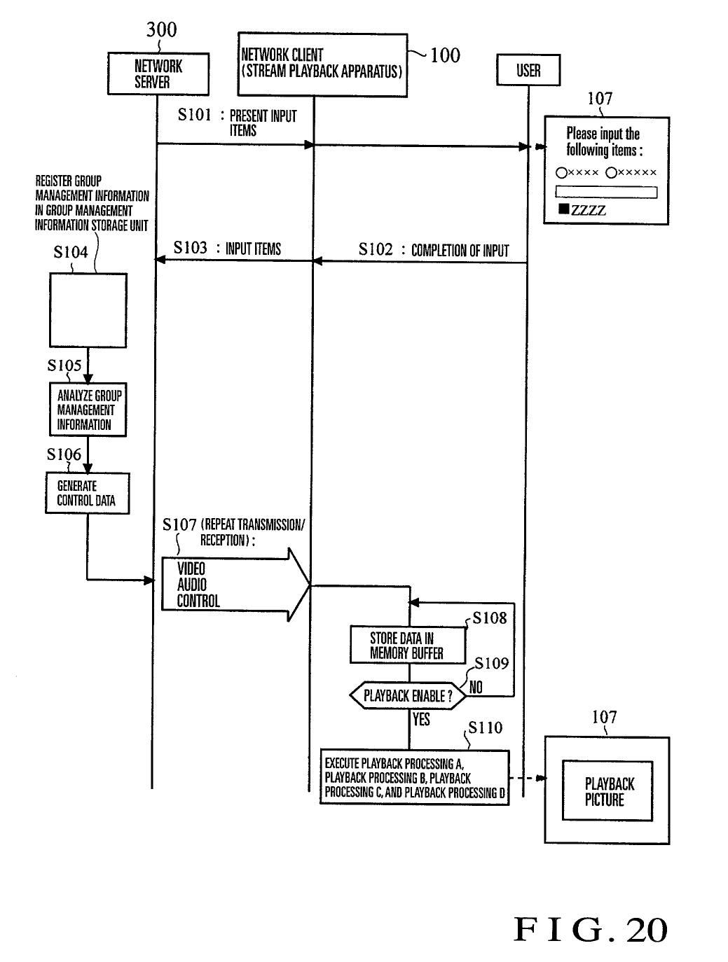

FIG. 20 shows an example in which group management information is similarly generated on the basis of data input from the user side, and control data is generated on the basis of the group management information and distributed to the playback apparatus 100. In FIG. 20, stream data are transmitted/received and played back in real time.

More specifically, similar to FIG. 18, the server 300 presents input items in step S101 of FIG. 20. If the server 300 receives data of the input items from the user side (step S103), it generates group management information based on the input data.

The server 300 registers the generated group management information in the storage unit 300B (step S104). If the user side instructs playback, the server 300 analyzes the group management information in the storage unit 300B, and generates control data based on the analysis result (steps S105 and S106). The server 300 transmits/receives data to/from the playback apparatus 100, and distributes the generated control data to the playback apparatus 100 together with video and audio data (step S107).

The playback apparatus 100 sequentially stores stream data from the server 300 in the memory buffer (step S108). If the playback apparatus 100 determines that the stream data can be played back (“Y” in step S109), it executes the playback processes A to D of playing back the video and audio data in the memory buffer in accordance with the control data in the memory buffer (step S110). Further, the playback apparatus 100 performs multitask processing of receiving stream data from the server 300 and storing them in the memory buffer.

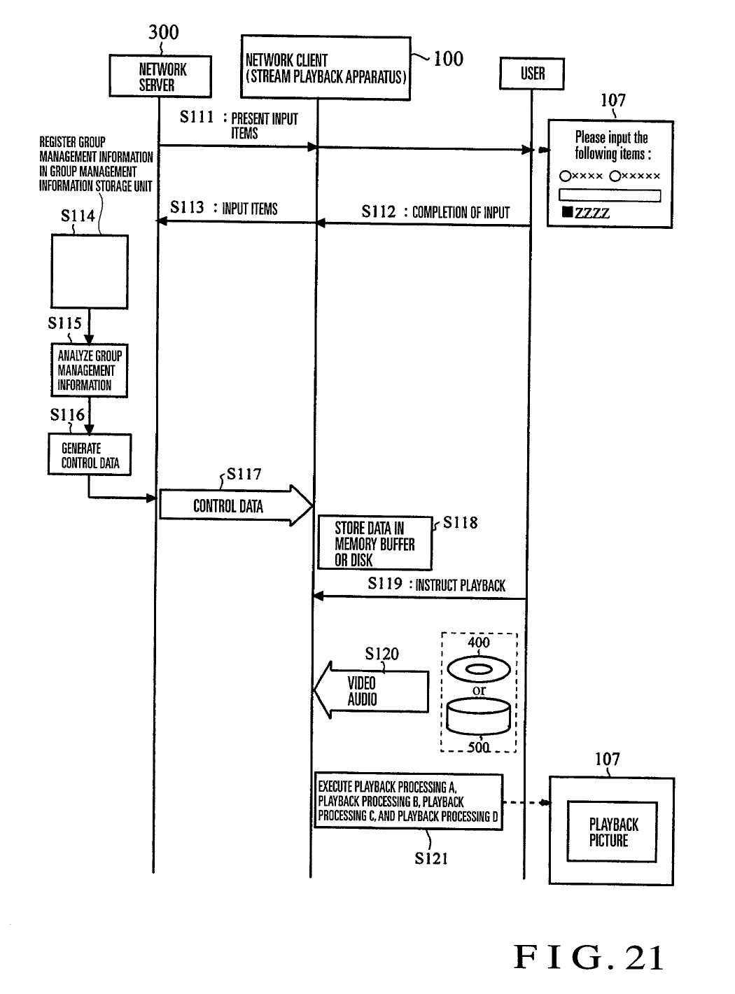

FIG. 21 shows an example in which group management information is similarly generated on the basis of data input from the user side, and control data is generated on the basis of the group management information and distributed to the playback apparatus 100. In FIG. 21, control data is distributed from the server 300, whereas video and audio data are distributed from the DVD 400 or storage device 500.

More specifically, similar to FIG. 18, the server 300 presents input items in step S111 of FIG. 21. If the server 300 receives data of the input items from the user side (step S113), it generates group management information based on the input data.

The server 300 registers the generated group management information in the storage unit 300B (step S114). The server 300 analyzes the group management information in the storage unit 300B, generates control data based on the analysis result (steps S115 and S116), and distributes the generated control data to the playback apparatus 100, which stores it in the memory buffer or disk (steps S117 and S118).

If the user side instructs playback (step S119), the playback apparatus 100 receives video and audio data from the DVD 400 or storage device 500 (step S120). The playback apparatus 100 reads out the stored control data, and executes the playback processes A to D of playing back the video and audio data in accordance with the control data (step S121).

As has been described above, the present invention comprises a first input means for receiving multimedia information including video and audio data distributed from a first distribution source, a second input means for receiving control information distributed from a second distribution source, and a playback means. The playback means plays back the multimedia information received by the first input means on the basis of the control information received by the second input means. The multimedia information in the first distribution source, e.g., DVD-ROM can be played back on the basis of the control information distributed from the second distribution source, e.g., external network server. If the control information is supplied to the playback means as control information in a playback order different from the contents of an IFO file in the DVD-ROM, the multimedia information can be played back in the playback order different from the contents of the IFO file without replacing the IFO file in the DVD-ROM with another IFO file, and illicit copying or tamper of the IFO file by a third party can be prevented.

What is claimed is:

1. A multimedia information playback apparatus comprising:
first input means for receiving multimedia information including video data and audio data distributed from a first distribution source;
second input means for receiving control information distributed from a second distribution source; and
playback means for playing back the multimedia information received by said first input means on the basis of the control information received by said second input means.

2. An apparatus according to claim 1, wherein
a storage device for storing the multimedia information, and a network server for distributing the control information are respectively arranged as the first and second distribution sources, and
said playback means plays back the multimedia information which is distributed from the storage device and received by said first input means, on the basis of the control information which is distributed from the network server and received by said second input means.

3. An apparatus according to claim 1, wherein
a network server for distributing the multimedia information and the control information is arranged as the first and second distribution sources, and
said playback means plays back the multimedia information which is distributed from the network server and received by said first input means, on the basis of the control information which is distributed from the network server and received by said second input means.

4. An apparatus according to claim 1, wherein
a storage device for storing the multimedia information and the control information, and a network server for distributing the control information are respectively arranged as the first and second distribution sources,
said playback means has a first playback mode in which said playback means plays back the multimedia information which is distributed from the storage device and received by said first input means, on the basis of the control information which is distributed from the storage device and received by said second input means, and a second playback mode in which said playback means plays back the multimedia information which is distributed from the storage device and received by said first input means, on the basis of the control information which is distributed from the network server and received by said second input means, and
said apparatus further comprises switching means for switching a playback mode to either one of the first and second playback modes.

5. An apparatus according to claim 4, wherein said switching means comprises:
authentication means for authenticating the network server upon reception of a switching request signal from a user; and
means for switching the playback mode of said playback means to the second playback mode when said authentication means authenticates the network server as an authentic network server.

6. An apparatus according to claim 4, wherein said playback means comprises:
a first navigator unit for reading out the control information in the storage device by said second input means in the first playback mode, analyzing the readout control information, and controlling read of the multimedia information in the storage device in accordance with an analysis result, and
a second navigator unit for controlling read of the multimedia information in the storage device on the basis of the control information distributed from the network server in the second playback mode.

7. An apparatus according to claim 3, wherein
the network sever generates group management information for managing a plurality of users having similar personal information as one group, and generates based on the group management information the control information for controlling playback of the multimedia information, and
said playback means plays back the multimedia information on the basis of the generated control information.

8. An apparatus according to claim 3, wherein
said playback means comprises determination means for, when change operation of the control information by a user is detected during playback of the multimedia information, determining whether to receive the change operation, in accordance with personal information of the user, and
when said determination means determines that the change operation of the control information is receivable, said playback means plays back the multimedia information on the basis of the control information changed in accordance with user operation.

9. An apparatus according to claim 3, wherein
the network server distributes multimedia information of digital broadcasting having a plurality of channels, and
said playback means plays back multimedia information of a channel corresponding to the control information.

10. An apparatus according to claim 3, wherein
the control information contains a program for checking user operation contents, and
when user operation is detected during playback of the multimedia information, said playback means executes the program, and plays back multimedia information corresponding to the user operation contents.

11. A multimedia information playback method comprising:
the first step of receiving multimedia information having video data and audio data distributed from a first distribution source;
the second step of receiving control information distributed from a second distribution source; and
the third step of playing back the multimedia information received by execution of the first step on the basis of the control information received by execution of the second step.

12. A method according to claim 11, wherein
a storage device for storing the multimedia information, and a network server for distributing the control information are respectively arranged as the first and second distribution sources, and
the third step comprises the fourth step of playing back the multimedia information which is distributed from the storage device and received by execution of the first step, on the basis of the control information which is distributed from the network server and received by execution of the second step.

13. A method according to claim 11, wherein
a network server for distributing the multimedia information and the control information is arranged as the first and second distribution sources, and
the third step comprises the fifth step of playing back the multimedia information which is distributed from the network server and received by execution of the first step, on the basis of the control information which is distributed from the network server and received by execution of the second step.

14. A method according to claim 11, wherein
a storage device for storing the multimedia information and the control information, and a network server for distributing the control information are respectively arranged as the first and second distribution sources,
the third step comprises the sixth step of playing back the multimedia information which is distributed from the storage device and received by execution of the first step, on the basis of the control information which is distributed from the storage device and received by execution of the second step, and the seventh step of playing back the multimedia information which is distributed from the storage device and received by execution of the first step, on the basis of the control information which is distributed from the network server and received by execution of the second step, and
the method further comprises the eighth step of executing either one of the sixth and seventh steps.

15. A method according to claim 14, wherein the eighth step comprises:
the ninth step of authenticating the network server upon reception of a switching request signal from a user; and
the 10th step of executing the seventh step when the network server is authenticated as an authentic network server on the basis of execution of the ninth step.

16. A method according to claim 14, wherein the third step comprises:
the 11th step of reading out the control information in the storage device on the basis of execution of the second step in executing the sixth step, analyzing the readout control information, and controlling read of the multimedia information in the storage device in accordance with an analysis result; and
the 12th step of controlling read of the multimedia information in the storage device on the basis of the control information distributed from the network server in executing the seventh step.

17. A method according to claim 13, wherein
the network sever comprises the 13th step of generating group management information for managing a plurality of users having similar personal information as one group, and generating based on the group management information the control information for controlling playback of the multimedia information, and
the third step comprises the 14th step of playing back the multimedia information on the basis of the control information generated by execution of the 13th step.

18. A method according to claim 13, wherein the third step comprises:
the 15th step of, when change operation of the control information by a user is detected during playback of the multimedia information, determining whether to receive the change operation, in accordance with personal information of the user; and
the 16th step of, when the change operation of the control information is determined to be receivable by execution of the 15th step, playing back the multimedia information on the basis of the control information changed in accordance with user operation.

19. A method according to claim 13, wherein
the network server comprises the 17th step of distributing multimedia information of digital broadcasting having a plurality of channels, and
the third step comprises the 18th step of playing back multimedia information of a channel corresponding to the control information.

20. A method according to claim 13, wherein
the control information includes a program for checking user operation contents, and
the third step comprises the 19th step of, when user operation is detected during playback of the multimedia information, executing the program, and playing back multimedia information corresponding to the user operation contents.
